(19) United States
(12) Patent Application Publication
(10) Pub. No.: US 2019/0346315 A1
(43) Pub. Date: Nov. 14, 2019

(54) Sheathed Thermocouple

(71) Applicant: Tesona GmbH & Co. KG, Horselberg/Hainich (DE)

(72) Inventors: Andreas Schmidt, Bad Liebenstein (DE); Heiko Lantzsch, Eisenach (DE)

(21) Appl. No.: 16/408,090

(22) Filed: May 9, 2019

(30) Foreign Application Priority Data
May 9, 2018 (DE) 10 2018 111 238.6

(51) Int. Cl. G01K 7/08; G01K 1/08

(52) U.S. Cl. CPC G01K 7/08; G01K 1/08

(57) ABSTRACT

A sheathed thermocouple component has at least a sheath housing with at least one thermocouple and electrical insulation therein. The sheath housing has an outer diameter and a wall thickness relative to a cross section of the at least one thermocouple, and a ratio of the wall thickness to the outer diameter is in the range of 0.17 to 0.45. Such a sheathed thermocouple component can be manufactured efficiently and has a number of advantageous uses.

### CROSS-REFERENCE TO RELATED APPLICATION

This application claims priority to German Patent Application No. 10 2018 111 238.6 filed on May 9, 2018, the disclosure of which including the specification, the drawings, and the claims is hereby incorporated by reference in its entirety.

### FIELD OF THE INVENTION

The present invention relates to a sheathed thermocouple, in particular a component or a rod for a functional sheathed thermocouple. Sheathed thermocouples are used in particular for measuring temperatures, for example in corrosive and/or hot environments.

### BACKGROUND OF THE INVENTION

A sheathed thermocouple is understood in particular to mean a temperature sensor that is designed essentially with two metal wires that are joined or welded together at one end to form a so-called heat-sensitive point or measuring point. The sheathed thermocouple is designed with a protective metal tube that encloses the two metal wires and the measuring point. An insulation material, which may be designed as a filling and/or coating between the metal wires and the protective tube, is provided between the metal wires and the protective tube.

Such sheathed thermocouples that are used in hot or corrosive environments must have various properties. A good temporal response characteristic by the sensor, in particular due to good heat transmission from the outside toward the thermocouple, thermal or electrical insulation, and/or fatigue strength are of particular importance. In this regard, even though a number of different designs of sheathed thermocouples have been proposed, there is a need for improvement, specifically in conjunction with the technical challenge described above.

### SUMMARY OF THE INVENTION

On this basis, the object of the present invention is to provide a sheathed thermocouple component that at least partially mitigates the problems described with regard to the prior art. In particular, a sheathed thermocouple component is provided that allows quicker and/or more precise detection of the temperature, at the same time preferably ensuring high fatigue strength of the thermocouple during use in a corrosive and/or hot environment. Furthermore, a method is provided with which a suitable sheathed thermocouple rod may be manufactured. Moreover, preferred uses of a sheathed thermocouple component of the type proposed here are provided.

These objects are achieved with a sheathed thermocouple component according to the features of Claim 1. The object is likewise achieved by a method for manufacturing a sheathed thermocouple rod as set forth by the features of Claim 9. Advantageous refinements of the sheathed thermocouple component, a method for manufacturing same, and use of same are set forth in the dependent claims. The features individually stated in the claims may be combined in any technologically meaningful manner, resulting in preferred embodiment variants of the present invention. The following description, in particular also in conjunction with the figures, explains these variants and provides additional exemplary embodiments.

This is made possible by a sheathed thermocouple component having at least the following parts: a sheath housing with at least one thermocouple and electrical insulation therein. The sheath housing has an outer diameter and a wall thickness in relation to a cross section of the at least one thermocouple. A ratio of the wall thickness to the outer diameter is in the range of 0.17 to 0.45.

The sheathed thermocouple component may in particular be a rod-shaped assembly that includes the stated parts. The sheath housing is in particular designed in the manner of a protective tube, and is preferably formed with a metallic layer. The sheath housing preferably has an essentially cylindrical cross section. The sheath housing preferably has the same wall thicknesses in a cross section and in the circumferential direction. The wall thickness as well as the outer diameter may optionally vary in an axial direction of extension of the sheath housing. For the case that the wall thickness has a different design in the axial direction of extension of the sheath housing, the following discussion is intended to likewise apply at least for the predominant portion of the sheath housing, or even for the entire axial extension of the sheath housing.

The outer diameter of the sheath housing is defined in particular by the dimensions of the outer, radially opposite surface sections of the sheath housing. Here as well, the sheath housing may be designed, for example, with a tapering area and/or a tip having a reduced outer diameter.

A single thermocouple, i.e., a pair of wires or a pair of thermocouple wires as described at the outset, is preferably provided in the sheathed thermocouple component. Essentially, the so-called Seebeck effect is relied on for measuring the temperature. An electrical charge displacement occurs when there is a temperature difference along a thermocouple. The magnitude of the charge displacement depends on the electrical properties of the selected material of the thermocouple. If two wires made of different materials are joined together at a location and are subjected to a temperature difference, a voltage is present at the two open ends. This voltage is a function of the temperature difference along the two wires. In this way, the temperature at the measuring point may be deduced from the tapped voltage. A thermocouple is understood here in particular to mean a thermocouple wire or a pair of joined thermocouple wires.

Electrical insulation is provided between the sheath housing and the at least one thermocouple to avoid electrical contact and/or as thermal protection. The electrical insulation preferably encloses the thermocouple or the thermocouples completely. In particular, the entire inner cavity formed by the sheath housing is filled with the electrical insulation. It is possible for the electrical insulation to be gaseous. The electrical insulation preferably includes a solid material or is formed completely from a solid material. The sheath housing and/or the at least one thermocouple may optionally be coated with electrical insulation.

In addition, it is proposed that the (single) wall thickness of the sheath housing is in a fixed ratio to the outer diameter. Thus, the ratio of the wall thickness to the outer diameter is to be selected in the range of 0.17 to 0.45. Problems may arise with regard to fatigue strength and/or measuring accuracy for a value less than 0.17. A value of greater than 0.45 may result in higher material expenditure and/or more complicated manufacture and/or inadequate electrical insulation (for use at elevated temperatures). In consideration of different materials for the housing, the lower limit may be set to a value of at least 0.2 or even at least 0.28. Particularly preferred ranges for the ratios of the wall thickness to the outer diameter are 0.2 to 0.45 and in particular 0.28 to 0.45.

It is possible to limit the ratios of the wall thickness to the outer diameter to a range of 0.35 to 0.42, resulting in an improved embodiment variant with regard to fatigue strength and response characteristic.

The sheath housing preferably rests directly against the electrical insulation, and is also preferably completely metallic.

The sheath housing may have a multi-layer construction. For example, the sheath housing may have an inner layer and an outer layer. Even further metallic layers may also be present.

For example, a (likewise metallic) middle layer may be present as a further (third) layer. The sheath housing may also have four, five, or more layers.

The term “completely metallic” is understood in particular to mean that no nonmetallic layers exist, in particular a gaseous intermediate layer or a protective layer, between metallic layers of the sheath housing (metallic inner layer, metallic outer layer, etc.).

In particular, a protective cap placed over the sheath housing is not considered as part of the sheath housing. This applies in particular when this protective cap is situated at a distance from the sheath housing.

A radial insulation distance of the at least one thermocouple from the sheath housing may be less than the wall thickness of the sheath housing. This reflects the fact in particular that the wall thickness is greater than in conventional embodiments of sheathed thermocouples, thus simultaneously improving the thermal conductivity and the heat transmission. In addition, as a result of the enlarged portion of the wall thickness of the sheath housing, a portion of the fatigue strength requirements are taken over by the sheath housing, so that the electrical insulation may also be reduced. This reduces the clearance that extends radially adjacent to the at least one thermocouple and toward the sheath housing, without long-term impairment of the functionality of the thermocouple.

The sheath housing may be made of a material that has a tensile strength (Rₘ) of at least 350 newtons per square millimeter (N/mm²) at a temperature of 700° C. A tensile strength of at least 500 N/mm² at a temperature of 700° C. is preferably provided. Such an embodiment of the material of the sheath housing is regarded as advantageous, taking into account the durability and the insulation distances between the thermocouple and the sheath housing, which may optionally be selected to be small.

The sheath housing may be made of a material having a thermal conductivity of at least 20.0 or at least 22.5 watts per meter-kelvin (W/mK). This thermal conductivity is preferably stated for a temperature of 600° C. The thermal conductivity is preferably in a range of 20.0 to 29.5 W/mK at a temperature range of 600° C. to 900° C.

The sheath housing may be made of a material from the following group: nickel-chromium steel, stainless steel.

For a suitable nickel-chromium steel, in particular a steel is selected in which the chromium component is in the range of 20 to 25 weight percent (wt %) and is based on nickel. A nickel-chromium-cobalt-molybdenum steel is preferably selected. The cobalt component may be in the range of 9.5 to 15 wt %. The molybdenum component may be in the range of 7 to 11 wt %.

The electrical insulation may include a material from the following group: aluminum oxide, magnesium oxide. It is very particularly preferred that the sheath housing is filled with the electrical insulation, so that the at least one thermocouple is completely enclosed by the electrical insulation.

The outer diameter of the sheathed thermocouple component, in particular the sheath housing, may be up to 3.0 millimeters (mm). The outer diameter is preferably in the range of 2.2 to 2.8 mm. A thermocouple wire preferably has a wire diameter of approximately 0.5 mm. The outer diameter of the sheathed thermocouple component is to be determined in particular in a central area, in particular at a distance from an (optionally locally tapered) end or a tip of the sheathed thermocouple component.

In one preferred embodiment variant, the outer diameter, at least in areas, may be slightly greater than 3.0 millimeters (mm), namely, up to 4.5 millimeters (mm) maximum. This may apply in particular for areas that are a farther distance from the measuring tip, and in which increased mechanical stability of the sheathed thermocouple component is desired. However, it is particularly preferred that the entire sheathed thermocouple component has an outer diameter of up to 3.0 mm.

The outer diameter does not include further protective layers provided on the outside around the sheath housing, which are designed, for example, as a sleeve (in particular a protective sleeve).

In one preferred embodiment variant, the sheath housing of the sheathed thermocouple component has at least one inner layer and an outer layer, the inner layer and the outer layer being metallic.

This is in particular a multi-wall or multi-ply sheath housing. The individual layers (inner layer and outer layer) preferably rest directly against one another, and in one preferred embodiment variant are even integrally joined together. In particular, between the individual layers there is no intermediate layer made of a different (nonmetallic) material.

Providing multiple plies/layers then allows a further benefit by use of different materials/material combinations.

It is particularly preferred that an inner layer is made of ferrite, and an outer layer is made of austenite and/or a chromium-nickel alloy. For example, the alloys Inconel 617 or Inconel 601 may be used as alloy for the outer layer.

The advantage of an inner layer made of ferrite is a high thermal conductivity, which is generally in a range of 25 watts per meter-kelvin (W/m K). Good heat transfer from the outside (outside the sheath housing) to the inside (to the thermocouple) may thus be achieved by using an inner layer made of ferrite. The sheathed thermocouple component can thus respond quickly to temperature changes.

The advantage of an outer layer made of austenite and/or a chromium-nickel alloy is in particular increased protection against embrittlement and environmental influences. In particular exhaust gases, whose temperature may be detected with the described sheathed thermocouple, are very aggressive. Higher resistance may be achieved by use of an outer layer made of austenite and/or a chromium-nickel alloy; in particular, resistance against chemical effects is meant here.

In particular the combination of an inner layer made of ferrite and an outer layer made of austenite and/or a chromium-nickel alloy ensures on the one hand good responsiveness to temperature changes, and on the other hand good durability. Both the inner layer and the outer layer result in mechanical stability of the sheathed thermocouple assembly.

As an example, the thickness of the inner layer may correspond to the thickness of the outer layer. The term “thickness” is understood here to mean the percentage of the respective layer in relation to the overall wall thickness of the sheath housing. In other preferred embodiment variants, the ratio of the thickness of the inner layer to the thickness of the outer layer is increased from 50%/50% to up to 80% inner layer/up to 20% outer layer, for example. Sufficient resistance is achieved by the remaining thickness of the outer layer of at least 20%. At the same time, the thickness of the inner layer of up to 80% results in very good thermal conductivity. The thicknesses of the inner layer and the outer layer may be suitably set, depending on the application.

According to another aspect, a method for manufacturing a sheathed thermocouple rod is proposed, having at least the following steps:
a. Providing an assembly having at least a sheath housing with at least one thermocouple and electrical insulation therein, wherein the sheath housing has an outer diameter and a wall thickness relative to a cross section of the at least one thermocouple, and a ratio of the wall thickness to the outer diameter is in the range of 0.17 to 0.45,
b. Deforming the assembly, wherein the outer diameter and the wall thickness are reduced, and the ratio of the wall thickness to the outer diameter (essentially or continuously) remains in the range of 0.17 to 0.45.

According to step a, an assembly is very particularly preferably provided that essentially already corresponds to the design of the sheathed thermocouple component. For installing the assembly, a cross section with respect to the sheath housing is to be selected that is greater, in absolute terms, than is necessary or effective for the final sheathed thermocouple that is to be used. This assembly may be merely a rod assembly. When the term “thermocouple” is used, this may be applicable to one or two thermocouple wires; a functional arrangement of the thermocouple (possibly only achievable by welding or connection to a voltage source) is not necessary here.

The thermocouple in question, as the rod material, which is seamless or welded from the desired sheath material, may first be inserted into a tube section. The inner cavity around the thermocouple may then be uniformly filled with insulation material (magnesium oxide and/or aluminum oxide, for example). The insulation material may be supplied in powdered form or also as a preform/pellet. After filling, the thermocouple is distributed uniformly in the interior to avoid sizable air inclusions. To reduce absorption of moisture by the insulation material during the process, the joining may take place at elevated temperature.

The tube section may undergo a cleaning step beforehand so that it is clean inside and free of impurities. The insulation material may be predried and/or cleaned before it is inserted into the tube section. After these parts have been joined to form a component, the ends of the tube section may be closed airtight.

In step b, this assembly is now stretched along the direction of extension of the assembly, i.e., along the course of the thermocouples, which is usually accompanied by a drawing process as a deformation operation. The entire assembly is hereby tapered essentially uniformly. This drawing process should be designed in such a way that after step b the ratio of the wall thickness to the outer diameter is still in the range of 0.17 to 0.45. Thus, there may be no harm in the value possibly temporarily leaving this range during step b, and/or the actual value of the ratio varying within the range, provided that the value range is maintained after conclusion of step b. However, it is preferred that the value does not leave the value range during step b.

After the optionally mineral-insulated assembly has been produced in the initial dimensions, multiple drawing stages may be carried out in which the material of the sheath housing is strengthened and the outer diameter is reduced in stages. The ratio of length to diameter of the thermocouple in the interior may be largely maintained during the drawing stages. Thus, even in the production of fairly small outer diameters of the assembly, sufficient insulation from the sheath material or from one another is provided.

At least one intermediate annealing process may be carried out between the drawing stages, depending on the intensity of the drawing process. Pickling may also optionally be carried out to remove impurities and/or annealing colors that result from the drawing process.

After drawing to the desired final dimensions has been completed, a final annealing process may be carried out in which material stresses are removed and, for example, the surface quality may be adjusted.

A drawing process is preferably preferred as the method for deforming the thermocouple. The deformation of the assembly in step b thus in particular involves drawing of the assembly to reduce the outer diameter while maintaining the ratio.

Here as well, however, other methods for deforming the thermocouple with the aim of reducing the outer diameter while maintaining the ratio are included. Another variant of the deformation is hammering, for example, in which the thermocouple is deformed by blows from a hammer, thus achieving a reduction in the outer diameter while maintaining the ratio.

After the deformation or with the deformation, an elongated assembly is now present that may be cut to length as needed, in particular taking into account the future use as a sheathed thermocouple sensor. This may take place in a sawing or cutting process.

This blank should be processed in a timely manner to minimize absorption of moisture by the insulation material, which may be hygroscopic.

The two ends are subsequently machined.

It is possible to additionally carry out at least one reducing step for the so-called “hot side” (which forms the future measuring point), for example by hammering or rotary swaging.

In the reduced area or the “hot side,” initially a portion or small piece of the thermocouple and/or the insulation material may be removed or bored out. Adhering residues of the insulation material may subsequently be removed, for example by a type of sandblasting process. This is followed by production of the measuring point by joining or reshaping the two thermocouple wires and welding (laser welding, for example) to form an integrally joined unit. The resulting cavity may then be filled with insulation material.

A drying process may be introduced prior to the (gastight) closure of the “hot side,” depending on the machining duration in the preceding process steps.

Various technologies may be used for the closure, for example direct plasma welding, tumbling of the measuring tip, or laser welding with an additionally mounted bottom plug, or cap structures.

On the oppositely situated “cold” side, first a portion of the sheath material is removed to expose the interior wires of the thermocouple. This may take place, for example, by puncturing, followed by breaking off or grinding. The thermocouple wires may subsequently be freed of insulation material and cleaned on this “cold” side as well. In addition, insulation material may be pulled out beyond the sheath material edge in order to create an (interior) space for the seal. In special cases (very small outer diameters, for example) this may be dispensed with.

A drying process may be carried out once again before a gastight connection is established on this “cold side.” After drying, the “cold” side is closed with an electrically nonconductive material. Epoxy resin or glass, for example, may be used for this purpose. When this “cold” side is also closed gastight, the thermocouple is ready for further processing. Depending on the situation, a cable is attached to, or an evaluation electronics system is connected directly to, the thermocouple.

For finishing a sensor, this sheathed thermocouple rod may then be inserted, for example, into a retaining tube having a connecting head for the electrical wiring.

A sheathed thermocouple component, as proposed herein or manufactured according to a method as presented herein, is preferably used for determining a hot gas temperature that is at least occasionally at least 600° C. or at least 900° C.

Determining a temperature in a corrosive medium represents another use of such a sheathed thermocouple component.

Another use provided herein is determining a temperature with a fluid stream that varies over time with regard to pressure and temperature.

The uses stated herein meet particularly high demands with regard to response time and/or durability of such a sheathed thermocouple component, so that positive effects may be achieved specifically in these cases.

### BRIEF DESCRIPTION OF THE DRAWINGS

The invention and the technical background are explained in greater detail below with reference to the figures. The figures show exemplary embodiments, to which the invention, however, is not limited. In the interest of clarity, it is pointed out that the technical features illustrated in the figures may be extracted and also optionally combined with features of other figures and/or the description without taking further technical features in the same figure. If there is a technical need to combine characteristics of one technical feature with those of another technical feature, this is explicitly noted herein, so that these features may otherwise be freely combined.

The figures schematically show the following:

FIG. 1: shows one design of a sheathed thermocouple component,

FIG. 2: shows a sequence of the method for manufacturing a sheathed thermocouple rod, and

FIG. 3: shows another design of a sheathed thermocouple component.

### DETAILED DESCRIPTION OF THE PREFERRED EMBODIMENTS

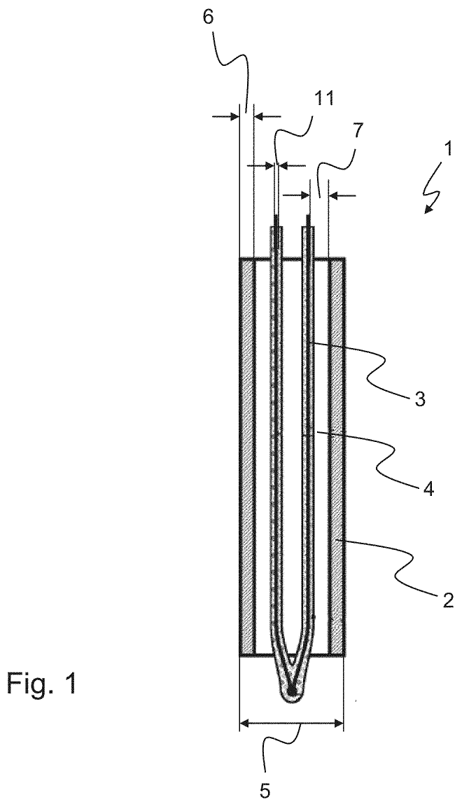

FIG. 1 shows a sheathed thermocouple 1 in cross section. The sheathed thermocouple component 1 is radially surrounded or enclosed by an outer sheath housing 2. On the end-face side, the thermocouple 3 may extend beyond both end faces of the sheath housing 2. At the top, FIG. 1 shows the connection for the evaluation electronics system, and at the bottom shows the measuring point in the area of the welded wires or tip. In this regard, the thermocouple extends through the cylindrical sheath housing. The at least one thermocouple 3 is positioned at a distance from the sheath housing. This is achieved in particular with electrical insulation 4. The electrical insulation 4 may be made from one material and/or from multiple electrically insulating materials. In the present case, the electrical insulation is designed, for example, in the manner of a coating on the thermocouple 3, and in addition an air gap is provided. However, it is also possible for the indicated interior of the sheath housing to be completely filled with (a single piece of) electrical insulation. The spaced-apart arrangement of the at least one thermocouple 3 and the sheath housing 2 may be illustrated in particular with reference to the radial insulation distance 7. The thermocouple 3 may have a wire diameter 11. With regard to the sheath housing 2, the wall thickness 6 is also indicated. In the present case, the wall thickness 6 is constant over the entire axial extension of the sheath housing 2, but this is not absolutely necessary. In addition, the outer diameter 5 is specified by the sheath housing 2. In the present case, the sheath housing is cylindrical over the entire axial extension, but this is not absolutely necessary. In the sheathed thermocouple component 1 schematically shown here, a ratio of the wall thickness 5 to the outer diameter 6 is to be maintained in the range of 0.17 to 0.45.

In the sheathed thermocouple 1 shown, the opposite sides or ends are to be closed gastight according to the above discussion, so that the thermocouple and the electrical insulation are accommodated and enclosed gastight in the sheath housing 2.

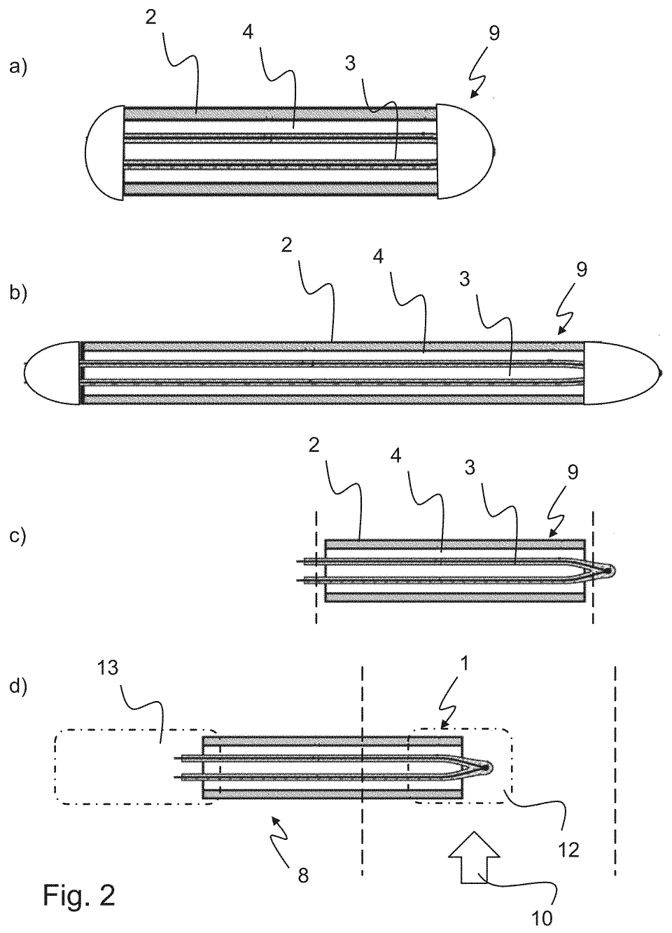

FIG. 2 illustrates the basic manufacture of a sheathed thermocouple rod or a sheathed thermocouple sensor with steps a, b, c, and d.

According to step a, an assembly 9 having at least one sheath housing 2 with at least one thermocouple 3 and electrical insulation 4 therein is initially provided. The outer diameter or the interior space of the sheath housing 2 is selected in particular in such a way that a precise, desired arrangement of the thermocouple and electrical insulation therein is made possible. The opposite sides or ends are also closed airtight before they undergo a subsequent drawing process.

In step b, the assembly is subsequently drawn once or multiple times, resulting in a cross-sectional reduction that accordingly decreases the outer diameter and tapers the wall thickness. At the conclusion of step b, the ratio of the wall thickness 6 to the outer diameter 5 is still in a value range of 0.17 to 0.45. An annealing process may be carried out afterward or between multiple drawing processes.

According to step c, the assembly 9 may then be cut to length with the desired axial extension, so that a sheathed thermocouple rod is present.

After the cutting to length, the opposite (hot and cold) sides or ends may once again be machined and subsequently closed gastight as explained above.

Completion to form a functional sensor may take place in a further step d, for example by providing the mounting 13 for fixing the measuring probe and/or for connecting to a measurement evaluation unit, on one side of the sheathed thermocouple component. On the opposite side a cap 12 may be mounted at or on the sheathed thermocouple component to provide better protection for the measuring point.

Such a sheathed thermocouple is preferably used for determining a temperature in its hot, corrosive, optionally pressure-pulsing gas stream 10.

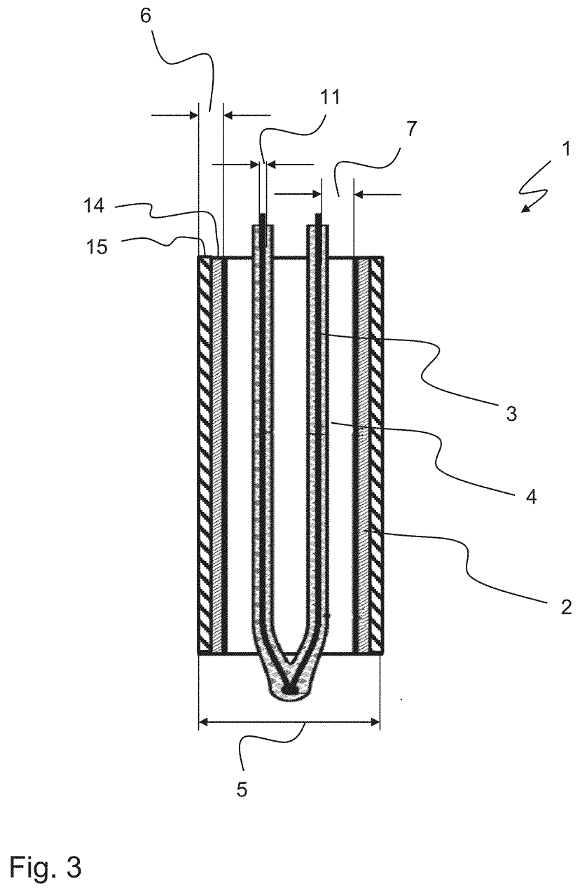

FIG. 3 shows another design of a sheathed thermocouple component 1. This design essentially corresponds to the disclosure in FIG. 1, to which reference is made in full. In this case, however, the sheath housing 2 is designed with two layers, namely, a (metallic) inner layer 14 and a (metallic) outer layer 15. The outer layer 15 completely covers the inner layer 14 for protection from the surroundings, at least in the area in which the sheathed thermocouple component is exposed to the medium whose temperature is to be monitored. This medium is preferably exhaust gas.

### LIST OF REFERENCE NUMERALS

1 sheathed thermocouple component

2 sheath housing

3 thermocouple

4 insulation

5 outer diameter

6 wall thickness

7 insulation distance

8 sheathed thermocouple rod

9 assembly

10 gas stream

11 wire diameter

12 cap

13 mounting

14 inner layer

15 outer layer

What is claimed is:

1. A sheathed thermocouple component, comprising a sheath housing with at least one thermocouple and electrical insulation therein, wherein the sheath housing has an outer diameter and a wall thickness relative to a cross section of the at least one thermocouple, and a ratio of the wall thickness to the outer diameter is in the range of 0.17 to 0.45.

2. The sheathed thermocouple component according to claim 1, wherein the ratio of the wall thickness to the outer diameter is in the range of 0.35 to 0.42.

3. The sheathed thermocouple component according claim 1, wherein a radial insulation distance of the at least one thermocouple from the sheath housing is less than the wall thickness of the sheath housing.

4. The sheathed thermocouple component according to claim 1, wherein the sheath housing is made of a material that has a tensile strength (Rₘ) of at least 350 N/mm² at a temperature of 700° C.

5. The sheathed thermocouple component according to claim 1, wherein the sheath housing is made of a material that has a thermal conductivity of at least 20.0 W/mK.

6. The sheathed thermocouple component according to claim 1, wherein the sheath housing includes a material from the following group: nickel-chromium steel, stainless steel.

7. The sheathed thermocouple component according to claim 1, wherein the electrical insulation includes a material from the following group: aluminum oxide, magnesium oxide.

8. The sheathed thermocouple component according to claim 1, wherein the outer diameter is less than 3.0 millimeters.

9. The sheathed thermocouple component according to claim 1, wherein the sheath housing has at least one inner layer and an outer layer, the inner layer and the outer layer being metallic.

10. A method for manufacturing a sheathed thermocouple rod, comprising:
a. providing an assembly having at least a sheath housing with at least one thermocouple and electrical insulation therein, wherein the sheath housing has an outer diameter and a wall thickness relative to a cross section of the at least one thermocouple, and a ratio of the wall thickness to the outer diameter is in the range of 0.17 to 0.45,
b. deforming the assembly, wherein the outer diameter and the wall thickness are reduced, and the ratio of the wall thickness to the outer diameter remains in the range of 0.17 to 0.45.

11. A method for determining a hot gas temperature that is at least occasionally at least 600° C. or at least 900° C. comprising providing the sheathed thermocouple component according to claim 1.

12. A method for determining a temperature in a corrosive medium comprising providing the sheathed thermocouple component according to claim 1.

13. A method for determining a temperature in a fluid stream that varies over time with regard to pressure and temperature medium comprising providing the sheathed thermocouple component according to claim 1.
